(19) United States
(12) Patent Application Publication
(10) Pub. No.: US 2009/0293010 A1
(43) Pub. Date: Nov. 26, 2009

(54) METHOD FOR SELECTING OBJECTS DISPLAYED ON AN OPERATOR SYSTEM

(76) Inventor: Michael Rock, Landau (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/469,950

(22) Filed: May 21, 2009

(30) Foreign Application Priority Data
May 23, 2008 (EP) 08009507.8

(51) Int. Cl. G06F 3/048; G05B 15/00

(52) U.S. Cl. 715/771; 700/83

(57) ABSTRACT

A method for selecting objects displayed on an operator system is described, the operator system being provided to operate and monitor a process flow in a plant and the objects representing plant components. Further, elements for selecting components of interest in a plant displayed on a display unit are provided.

### CROSS REFERENCE TO RELATED APPLICATIONS

This application claims priority of European Patent Application No. 08009507.8 EP filed May 23, 2008, which is incorporated by reference herein in its entirety.

### FIELD OF INVENTION

The invention relates to a method for selecting objects displayed on an operator system, with the operator system being provided to control and monitor a process flow in a plant and with the objects representing plant components. The invention also relates to an arrangement for implementing the method.

### BACKGROUND OF INVENTION

A method and arrangement of this type are known from the Siemens catalog “ST PCS 7—November 2007”, Chapters 5 to 7. A so-called operator system usually includes there an OS server and several OS clients, with which an operator can monitor the process flow and if necessary intervene therein. Provision is made for a so-called batch system in the form of a single user and/or client/server system for batch process automation and a so-called route control system likewise in the form of a single user and/or client/server system for controlling material handling by way of transport routes and road systems. Both the operator system as well as the batch and route control system is connected to one or several automation systems by way of a suitable bus, the latter, together with these systems, controlling one or several processes in a plant. By way of example, the batch system within the scope of a batch process to be controlled sequentially processes a formula comprising several formula phases, with an automation device connected correspondingly online thereto executing a function module assigned to each formula phase at said formula phase respectively. During this batch processing, the components of the plant which are needed for this batch process are indicated together with additional plant components of the plant to be controlled in the form of objects on a display unit of the operator system. Objects of transport routes, road systems or branched line paths are also shown on the display unit for instance, which, within the scope of a route controller, are needed and/or provided for material handling. The route controller determines suitable transport routes for a material flow in the plant and finally transmits suitable instructions to the automation device/s, as a result of which these activate corresponding hardware components in order to transport the material.

### SUMMARY OF INVENTION

As a result of the plurality of plant components displayed on the display unit, it is difficult for an operator to select the plant components associated with a batch controller and/or path controller in order to be able to operate these for instance.

An object of the present invention is to specify a method of the type cited in the introduction, which enables a simple selection of the components of interest in a plant shown on a display unit. Furthermore, an arrangement is created which is suited to implementing the method.

This object is achieved by a method and an arrangement as claimed in the claims.

It is advantageous for an operator to be able to more easily operate a process to be controlled. He/she may intentionally select actively connected components of the plant which are of interest, as a result of which a targeted operation is enabled. By way of example, actively connected objects of a batch controller (batch process) are automatically assigned an identifier in the form of a batch name, with which the operator can select the objects, with only the objects provided with the selected identifier being indicated; the objects not provided with the selected identifier are masked out. The clarity of the plant components to be operated is improved further as a result.

In the event that the objects not provided with the selected identifier are to be masked out, provision is made for the objects provided with the selected identifier to be marked, with the objects provided with the selected identifier being marked in color in one embodiment of the invention. Here too, the part of the plant to be monitored and operated is shown clearly and the probability of an operating error is reduced.

### BRIEF DESCRIPTION OF THE DRAWINGS

With reference to the drawing, in which an exemplary embodiment of the invention is shown, the invention, its embodiments as well as advantages are shown in more detail below, in which:

FIG. 1 shows components of a process control system

FIG. 2 shows a plant shown on an operator system and

FIG. 3 shows a cutout of the plant according to FIG. 2.

### DETAILED DESCRIPTION OF INVENTION

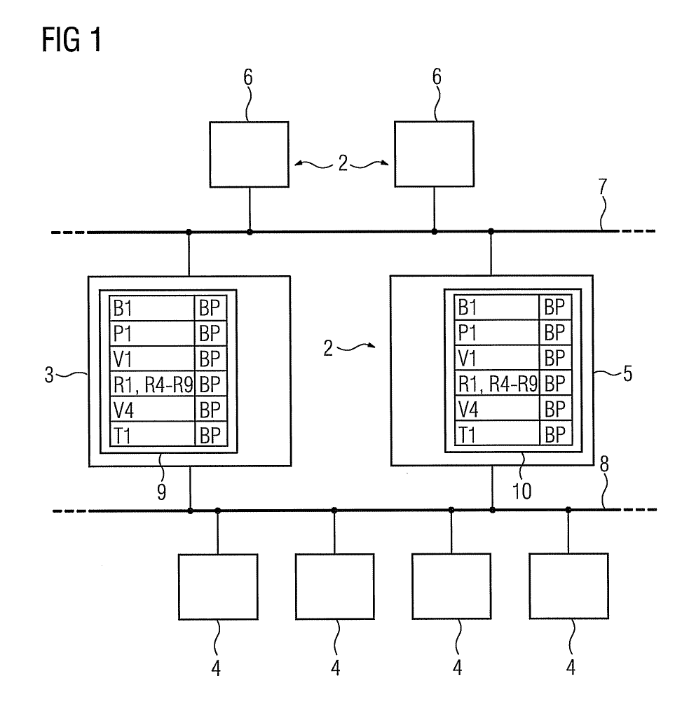

FIG. 1 identifies component parts of a process control system with 1, said process control system being provided with an operator system 2, a batch server 3 and automation devices 4. The process control system naturally comprises further components and/or automation components (not shown here), e.g. automation components in the form of sensors, actuators or decentralized peripheral devices connected to the automation devices 4, as well as engineering systems or maintenance stations. The operator system 2 is provided to operate and monitor a process flow in a plant and has an OS server 5 and several OS clients 6, with the operator system 2 and the batch server 3 being connected to the OS clients 6 and the automation devices 4 to exchange information by way of suitable bus connections 7, 8. Batch software 9 which can be executed on the batch server 3 controls the necessary plant components during a batch process, together with suitable hardware and software components of the automation devices 4 (not shown here), with these plant components, together with additional parts of the plant, being visually shown to an operator on one of the OS clients 6 in the form of objects. The batch process may be a dosing and heating process for instance for producing medicines, which means that the plant components needed for this comprise dosing containers, pumps, valves and boilers with associated transport routes, which are actively connected within the scope of this batch process.

In order merely to indicate the image of the plant components needed for this dosing and heating process on one of the OS clients 6 or in order to visually emphasize this image there, the batch software 9 of an OS software 10 which can be executed on the OS server 5 transmits an identifier for the necessary and actively connected plant components of this batch process. This identifier may be a batch name or a number for instance.

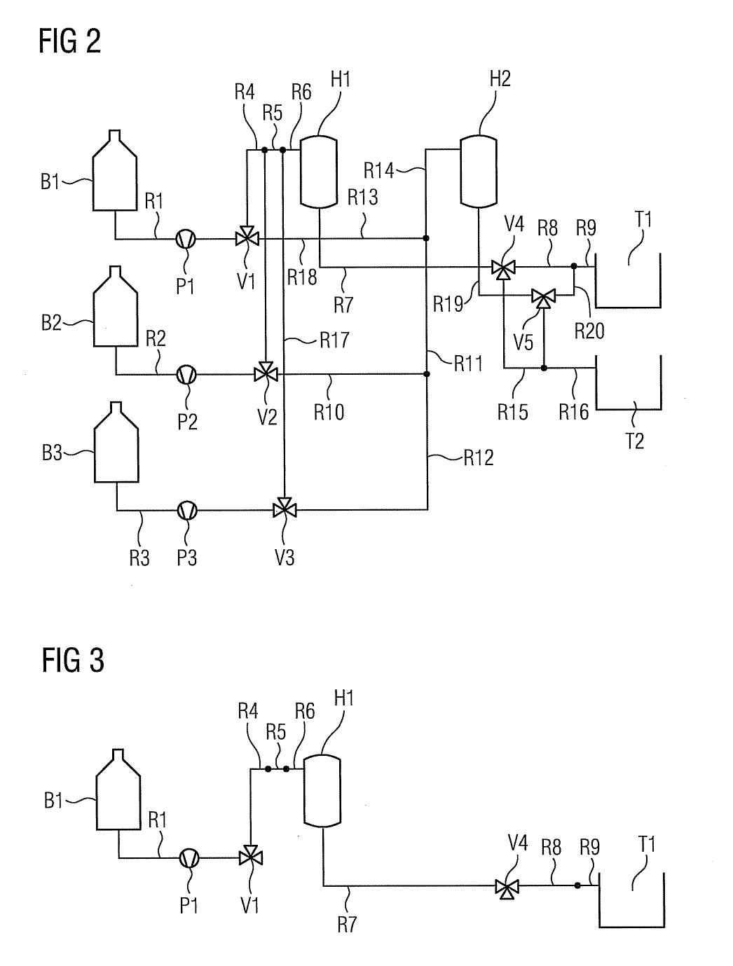

Reference is made in this context to FIG. 2, in which a plant is displayed on an operator system. Components of this plant are containers B1, B2, B3, pumps P1, P2, P3, valves V1, V2, V3, V4, V5, boilers H1, H2, tanks T1, T2 and conduit pipes R1, R2, . . . R20.

It is assumed that the container B1, the pump P1, the boiler H1, the valves V1, V4, the tank T1 and the associated conduit pipes R1, R5 . . . R9 are needed in order to realize a batch process with batch names BP, with the batch software 9 assigning the batch name or a number BP to these components as identifiers and transmitting this number BP to the OS software 10 of the OS server 5. This server 5 occupies e.g. a function key of a keypad or a field of a menu bar of one of the OS clients 6, with, in the event that an operator activates the function key or the menu bar, the OS server 5 only indicating those objects of these plant components provided with this number BP which are stored on the OS server 5 with this number BP, in other words the container B1, the pump P1, the boiler H1, the tank T1, the values V1, V4 and the associated conduit pipes R, R5 . . . R9, on one of the OS clients 6 (FIG. 3).

All other previously displayed plant components are by contrast masked out. In the event that the plant components not provided with the number BP are not to be masked out, provision can be made to display in color the objects provided with this number BP within the display of all plant components for instance. This alternative representation may likewise be activated by way of a function key or in a menu-controlled fashion.

1.-4. (canceled)

5. A method of selecting objects displayed on an operator system, the operator system being provided to operate and monitor a process flow in a plant and the objects representing plant components, comprising:
automatically providing actively connected objects with an identifier within a controlling;
indicating the identifier to an operator, wherein, when the identifier is selected by the operator, only the objects provided with the identifier are shown on the operator system.

6. A method of selecting objects displayed on an operator system, the operator system being provided to operate and monitor a process flow in a plant and the objects representing plant components, comprising:
automatically providing actively connected objects with an identifier within a controlling;
indicating the identifier to an operator, wherein, when the identifier is selected by the operator, the objects provided with the identifier are shown marked on the operator system.

7. The method as claimed in claim 5, wherein the controlling is a batch controlling.

8. The method as claimed in claim 5, wherein the controlling is a route controlling.

9. The method as claimed in claim 6, wherein the controlling is a batch controlling.

10. The method as claimed in claim 6, wherein the controlling is a route controlling.

11. The method as claimed in claim 6, wherein the objects provided with the selected identifier are marked in color.

12. An arrangement, comprising:
an operator system for displaying objects and for operating and monitoring a process flow in a plant, the objects representing plant components; and
a control device,
wherein objects actively connected to each other are automatically provided with an identifier by the control device,
wherein the control device transmits the identifier to the operator system which indicates the identifier to an operator, and
the operator system, when the identifier is selected by the operator, shows the objects provided with the identifier.

13. The arrangement as claimed in claim 12, wherein the operator system, when the identifier is selected by the operator, shows the objects provided with this identifier as marked.

14. The arrangement as claimed in claim 13, wherein the operator system marks the objects provided with the selected identifier in color.

15. The arrangement as claimed in claim 12, wherein the control device is a batch control device.

16. The arrangement as claimed in claim 12, wherein the control device is a route control device.
